(19) United States
(12) Patent Application Publication
(10) Pub. No.: US 2018/0287830 A1
(43) Pub. Date: Oct. 4, 2018

(54) INTERFERENCE NULLING FOR WI-FI FREQUENCY DOMAIN PROCESSING

(71) Applicant: QUALCOMM Incorporated, San Diego, CA (US)

(72) Inventors: Simone Merlin, San Diego, CA (US); Dung Ngoc Doan, San Diego, CA (US); Jialing Li Chen, San Diego, CA (US); Vinayak Chowdiah, San Diego, CA (US); Hemanth Sampath, San Diego, CA (US)

(21) Appl. No.: 15/472,073

(22) Filed: Mar. 28, 2017

(51) Int. Cl. H04L 25/03; H04L 29/06; H04W 52/52; H04B 17/336

(52) U.S. Cl. CPC H04L 25/03305; H04L 69/22; H04W 84/12; H04B 17/336; H04W 52/52

(57) ABSTRACT

This disclosure provides systems, methods and apparatuses for pre- and post-packet detection interference nulling. In some implementations, a method includes detecting at least a first part of an unscheduled Wi-Fi packet and performing a channel estimation. The method also may include estimating an interference on the Wi-Fi channel based on a known non-zero portion of the preamble of the Wi-Fi packet and nulling interference from the Wi-Fi channel during reception of at least a second part of the Wi-Fi packet. In some implementations, the method can determine an interference estimate based on at least one of a previously received packet or channel sampling for a Wi-Fi channel and computer a filter based at least in part on the interference estimate. The method also includes applying the filter to a received signal to null interference on the Wi-Fi channel at least before detection of a Wi-Fi packet.

### TECHNICAL FIELD

This disclosure relates to reducing interference in wireless communication systems, and particularly to techniques for reducing interference before and after detecting a packet.

### DESCRIPTION OF RELATED ART

Wireless communication systems are widely deployed to provide various types of communication content such as voice, video, packet data, messaging, broadcast, and so on. These systems may be multiple-access systems capable of supporting communication with multiple users by sharing the available system resources (such as time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems. A wireless network, for example a WLAN, such as a Wi-Fi (i.e., Institute of Electrical and Electronics Engineers (IEEE) 802.11) network may include an access point (AP) that may communicate with one or more stations (STAs) or mobile devices, otherwise known as user equipment (UEs). The AP may be coupled to a network, such as the Internet, and may enable a wireless device to communicate via the network (or communicate with other devices coupled to the AP). A wireless device may communicate with a network device bi-directionally. For example, in a WLAN, a STA may communicate with an associated AP via DL and UL. The DL (or forward link) may refer to the communication link from the AP to the station, and the UL (or reverse link) may refer to the communication link from the station to the AP.

Interference can be present in Wi-Fi systems and can cause packet loss. Because Wi-Fi is an asynchronous system where packets may be exchanged without a schedule, it can be difficult to correct for interference while still receiving the appropriate packets. Interference may be present before a packet is detected, occur during a packet reception, or appear after a packet is initially detected. In some instances, the sources of interference may be unknown and therefore hard to compensate for, or null. This is contrasted with cellular systems, which may be synchronous and scheduled.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method of wireless communication. The method can include detecting at least a first part of an unscheduled Wi-Fi packet transmitted over a Wi-Fi channel, performing a channel estimation on the Wi-Fi channel, estimating an interference on the Wi-Fi channel based on a known non-zero portion of the preamble of the Wi-Fi packet, and nulling interference from the Wi-Fi channel during reception of at least a second part of the Wi-Fi packet based at least in part on the channel estimate and the estimated interference.

Another innovative aspect of the subject matter described in this disclosure can be implemented in an apparatus for wireless communication. The apparatus can include means for detecting at least a first part of an unscheduled Wi-Fi packet transmitted over a Wi-Fi channel, means for performing a channel estimation on the Wi-Fi channel, means for estimating an interference on the Wi-Fi channel based on a known non-zero portion of the preamble of the Wi-Fi packet, and means for nulling interference from the Wi-Fi channel during reception of at least a second part of the Wi-Fi packet based at least in part on the channel estimate and the estimated interference.

Another innovative aspect of the subject matter described in this disclosure can be implemented in an apparatus for wireless communication. The apparatus can include a processor, memory in electronic communication with the processor, and instructions stored in the memory. The instructions may be operable to cause the processor to detect at least a first part of an unscheduled Wi-Fi packet transmitted over a Wi-Fi channel, perform a channel estimation on the Wi-Fi channel, estimate an interference on the Wi-Fi channel based on a known non-zero portion of the preamble of the Wi-Fi packet, and null interference from the Wi-Fi channel during reception of at least a second part of the Wi-Fi packet based at least in part on the channel estimate and the estimated interference.

Another innovative aspect of the subject matter described in this disclosure can be implemented in a non-transitory computer readable medium for wireless communication. The non-transitory computer-readable medium can include instructions operable to cause a processor to detect at least a first part of an unscheduled Wi-Fi packet transmitted over a Wi-Fi channel, perform a channel estimation on the Wi-Fi channel, estimate an interference on the Wi-Fi channel based on a known non-zero portion of the preamble of the Wi-Fi packet, and null interference from the Wi-Fi channel during reception of at least a second part of the Wi-Fi packet based at least in part on the channel estimate and the estimated interference.

In some implementations, estimating the interference can be based at least in part on a known or redundant waveform of the known non-zero portion of the preamble of the Wi-Fi packet.

In some implementations, detecting at least the first part of the data packet can include detecting a short training field (STF) of the data packet. The known non-zero portion of the preamble can be from one of the STF or a long training field (LTF) of the preamble.

In some implementations, the known non-zero portion of the preamble can correspond to a portion of the STF received after automatic gain control (AGC) settling and decoding or re-encoding of a signal (SIG) field.

In some implementations, a smoothing operation can be performed on the Wi-Fi channel or the interference estimate in the frequency domain. In some implementations, a frequency domain filter can be computed based at least in part on the estimated channel or the smoothed interference estimate.

In some implementations, nulling interference from the Wi-Fi channel can include applying the frequency domain filter to a received signal during reception of at least a second part of the Wi-Fi packet.

In some implementations, the smoothing operation can be calibrated based at least in part on a modulation and coding scheme (MCS), a signal to interference and noise ratio (SINR), or a number of receive antennas.

Another innovative aspect of the subject matter described in this disclosure can be implemented in a method of wireless communication. The method can include determining an interference estimate based on at least one of a previously received packet or channel sampling for a Wi-Fi channel, computing a filter based at least in part on the interference estimate, and applying the filter to a received signal to nullify interference on the Wi-Fi channel at least before detection of a Wi-Fi packet.

Another innovative aspect of the subject matter described in this disclosure can be implemented in an apparatus for wireless communication. The apparatus can include means for determining an interference estimate based on at least one of a previously received packet or channel sampling for a Wi-Fi channel, means for computing a filter based at least in part on the interference estimate, and means for applying the filter to a received signal to nullify interference on the Wi-Fi channel at least before detection of a Wi-Fi packet.

Another innovative aspect of the subject matter described in this disclosure can be implemented in an apparatus for wireless communication. The apparatus can include a processor, memory in electronic communication with the processor, and instructions stored in the memory. The instructions may be operable to cause the processor to determine an interference estimate based on at least one of a previously received packet or channel sampling for a Wi-Fi channel, compute a filter based at least in part on the interference estimate, and apply the filter to a received signal to nullify interference on the Wi-Fi channel at least before detection of a Wi-Fi packet.

Another innovative aspect of the subject matter described in this disclosure can be implemented in a non-transitory computer readable medium for wireless communication. The non-transitory computer-readable medium can include instructions operable to cause a processor to determine an interference estimate based on at least one of a previously received packet or channel sampling for a Wi-Fi channel, compute a filter based at least in part on the interference estimate, and apply the filter to a received signal to nullify interference on the Wi-Fi channel at least before detection of a Wi-Fi packet.

In some implementations, the filter can be applied to the received signal occurs based at least in part on at least one of: an absence of a determination that a packet was detected or an absence of a determination that an interference level may be below a threshold interference level.

In some implementations, the Wi-Fi channel can be monitored to detect a Wi-Fi packet using a legacy packet detector, wherein applying the filter to the received signal further may be based at least in part on an absence of detected legacy Wi-Fi packets.

In some implementations, the an overlapping basic service set (BSS) physical layer convergence procedure (PLCP) Protocol Data Unit (PPDU) can be detected, and the filter can be activated based at least in part on the detection of the overlapping BSS PPDU. In some implementations, the filter can be applied to the received signal occurs after the filter may be activated.

In some implementations, the interference can be periodically estimated via over the air sampling.

In some implementations, a null-space filter can be created based at least in part on the interference estimate, and the null-space filters can be applied to at least some of the interference while keeping at least some noise until a Wi-Fi packet can be detected.

In some implementations, the Wi-Fi packet can be detected after applying the filter to the received signal to null the at least some interference.

In some implementations, interference on the Wi-Fi channel can be detected based at least in part on at least one of: an energy level received at a receive chain, a ratio of energy of diagonal to energy of off-diagonal elements of the receive chain, or on detection of an interfering packet with a known length.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a block diagram of an example wireless communication system that supports interference nulling for Wi-Fi frequency domain processing.

FIG. 2 shows a swim diagram illustrating an example of a process of nulling interference at a wireless device.

FIGS. 3A-3D show block diagrams illustrating examples of packets and interfering signals received at a wireless device.

FIG. 4 shows a swim diagram illustrating another example of a process of nulling interference at a wireless device.

FIG. 5 shows a block diagram illustrating an example of pre-detection nulling architecture that supports interference nulling for Wi-Fi frequency domain processing.

FIGS. 6A-6B show block diagrams illustrating examples of packets and interfering signals received at a wireless device.

FIG. 7 shows a block diagram of an example wireless device that supports interference nulling for Wi-Fi frequency domain processing

FIG. 8 shows a block diagram of an example wireless device that supports interference nulling for Wi-Fi frequency domain processing.

FIG. 9 shows a diagram of a system including an example device that supports interference nulling for Wi-Fi frequency domain processing.

FIG. 10 is a flow chart illustrating an example of a method for post-detection interference nulling.

FIG. 11 is a flow chart illustrating an example of a method for pre-detection interference nulling.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

Interference experienced at a Wi-Fi device, whether it be an access point (AP) or a wireless station (STA), can degrade performance and even result in a failure to receive packets. When packets are unscheduled, such as in an asynchronous Wi-Fi network, packet loss may occur due to a receiving device not knowing when to compensate for interference on a channel. Techniques described herein null interference regardless of whether the packet is detected while the interference occurs.

In some implementations, a pre-detection nulling technique is described for use to aid in packet detection. In pre-detection nulling, interference is nulled even before a packet is detected. Estimates of the interference are made based on one or both of channel sampling and a previously detected packet. These estimates are applied to the received signal before a packet is detected. Once the interference is reduced, the Wi-Fi device may detect a packet.

In some implementations, a post-detection nulling technique is described for use in receiving a packet in which a portion has already been detected. Interference nulling for Wi-Fi when a portion of the packet is detected may include estimating the interference based on a known waveform in the preamble of the detected packet and then nulling the interference to receive the remainder of the packet.

Particular implementations of the subject matter described in this disclosure can be implemented to realize one or more of the following potential advantages. Wi-Fi systems may experience packet loss less frequently because interference may be reduced and throughput gains may be improved. Users may experience an improved quality of service (QoS) and faster communications due to reduced interference. Additionally, wireless devices may experience power savings.

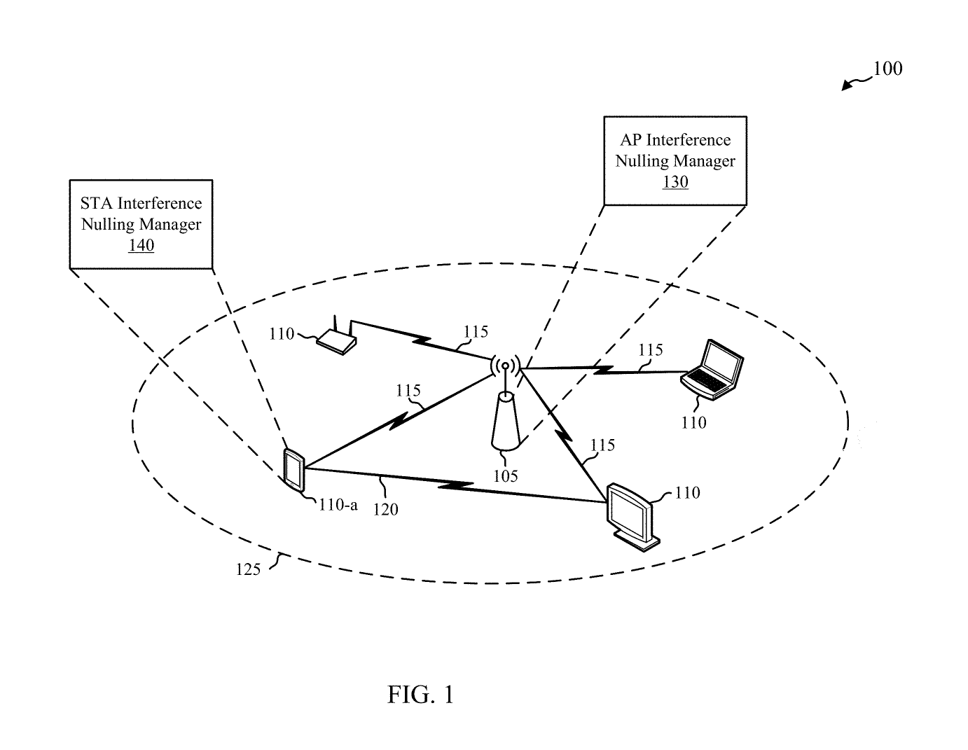

FIG. 1 shows a block diagram of a wireless communication system, in accordance with various aspects of the present disclosure. In this example, the wireless communication system is a wireless local area network (WLAN) 100 (also known as a Wi-Fi network) configured in accordance with various aspects of the present disclosure. The WLAN 100 may include an AP 105 and multiple associated stations (STAs) 110, which may represent devices such as mobile stations, personal digital assistant (PDAs), other handheld devices, netbooks, notebook computers, tablet computers, laptops, display devices (such as TVs, computer monitors, etc.), printers, appliances (kitchen appliances such as dishwashers and ovens, heating and cooling systems, security systems, lighting systems, smart sensors such as smart door lock sensors, etc.) and the like. In some implementations, the AP 105 is a gateway. The WLAN 100 may be a smart home network. In some implementations, the WLAN 100 may be an Internet of Things network. Techniques described herein provide interference nulling for pre- and post-detection packets.

While only one AP 105 is illustrated in FIG. 1, the WLAN 100 may have multiple APs 105. Each of the STAs 110, which also may be referred to as mobile stations (MSs), mobile devices, access terminals (ATs), user equipment (UE), subscriber stations (SSs), or subscriber units, may associate and communicate with an AP 105 via a communication link 115. Each AP 105 has a geographic coverage area 125 such that STAs 110 within that area can typically communicate with the AP 105. The STAs 110 may be dispersed throughout the geographic coverage area 125. Each STA 110 may be stationary or mobile.

The AP 105 and the associated STAs 110 may represent a basic service set (BSS) or an extended service set (ESS). The various STAs 110 in the network are able to communicate with one another through the AP 105. Also shown is a geographic coverage area 125 of the AP 105, which may represent a BSA of the WLAN 100. An extended network station associated with the WLAN 100 may be connected to a wired or wireless distribution system that may allow multiple APs 105 to be connected in an ESS.

A STA 110 may be located in the intersection of more than one geographic coverage area 125 and may associate with more than one AP 105. A single AP 105 and an associated set of STAs 110 may be referred to as a BSS. An ESS is a set of connected BSSs. A distribution system may be used to connect APs 105 in an ESS. In some cases, the geographic coverage area 125 of an AP 105 may be divided into sectors. The WLAN 100 may include APs 105 of different types (such as metropolitan area, home network, etc.), with varying and overlapping geographic coverage areas 125. Two STAs 110 also may communicate directly via a direct wireless link regardless of whether both STAs 110 are in the same geographic coverage area 125. Examples of the direct wireless links 120 may include Wi-Fi Direct connections, Wi-Fi Tunneled Direct Link Setup (TDLS) links, and other group connections. The STAs 110 and the APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In some other implementations, peer-to-peer connections or ad hoc networks may be implemented within the WLAN 100.

A STA 110 may include a STA interference nulling manager 140 that can determine an interference estimate and use it to null interference. As used herein, the phrases “to null interference” and “interference nulling” refer to receive-side operations for reducing or compensating for some or all interference on a wireless channel. As described in more detail below, the STA interference nulling manager 140 may be implemented by special-purpose hardware (such as an application-specific integrated circuit or specialized chipset), a processor programmed with instructions to perform a set of coexistence conflict management features, or a combination thereof. The STA interference nulling manager 140 may be used whether or not a packet has already been detected. The STA interference nulling manager 140 may serve other functions as well.

Likewise, the AP 105 may include an AP interference nulling manager 130 that can determine an interference estimate and use it to null interference. As described in more detail below, the AP interference nulling manager 130 may be implemented by special-purpose hardware (such as an application-specific integrated circuit or specialized chipset), a processor programmed with instructions to perform a set of coexistence conflict management features, or a combination thereof. The AP interference nulling manager 130 may be used whether or not a packet has already been detected. The STA interference nulling manager 140 may serve other functions as well.

Thus, the AP interference nulling manager 130 and the STA interference nulling manager 140 may be used to reduce interference at their respective receive chains. While some of the techniques described herein may be described specifically for an AP or a STA, it is to be understood that the techniques apply to either device. These techniques improve detection and reception of packets, reduce power consumption, improve efficiency of the network, and improve user experience.

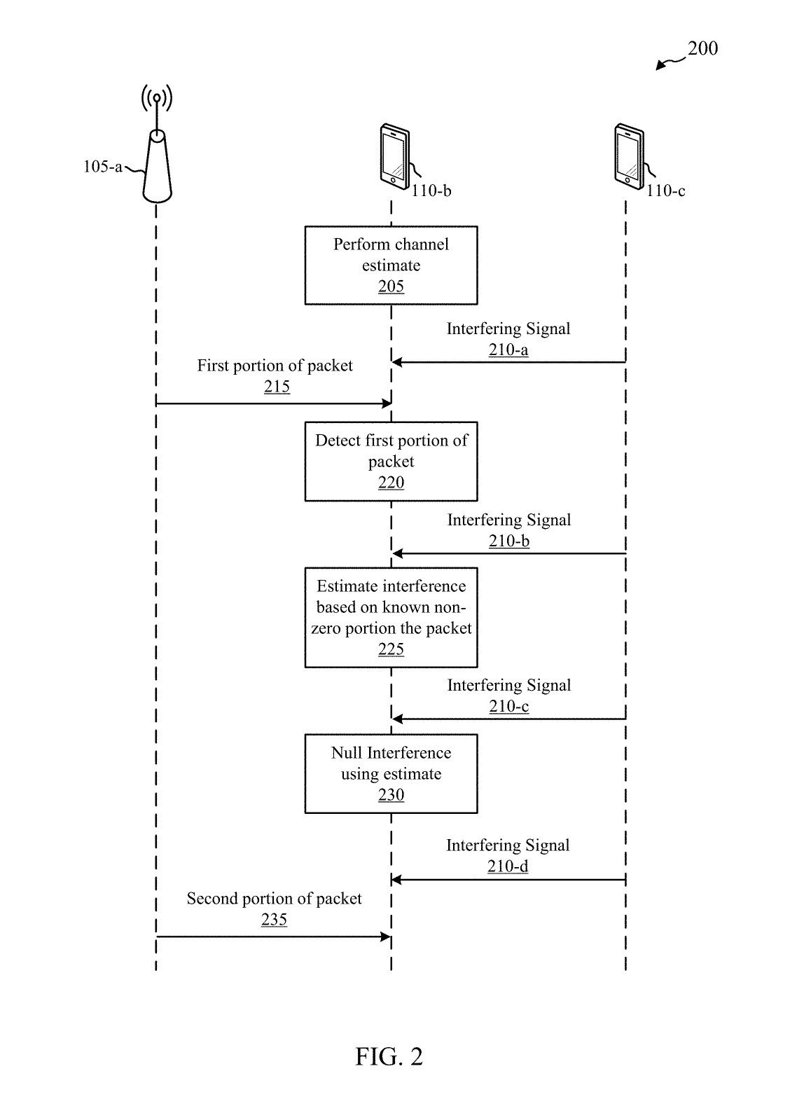

FIG. 2 shows a swim diagram illustrating an example of a process 200 of nulling interference at a wireless device. The process 200 includes a STA 110-b, an AP 105-a, and another STA 110-c. The STAs 110-b and 110-c may be an example of one or more aspects of the STAs 110 of FIG. 1. The AP 105-a may be an example of one or more aspects of the AP 105 described with reference to FIG. 1. Although this example illustrates the STA 110-b performing the interference nulling techniques, the AP 105-a also may perform these techniques.

The example of FIG. 2 illustrates post-detection interference nulling techniques. That is, the STA 110-b detects at least a first portion of a Wi-Fi packet (also referred to herein as a “packet”) and then applies the nulling techniques. Subsequent Figures will illustrate the pre-detection interference nulling techniques.

As shown, the STA 110-b is within communication range of the AP 105-a and the STA 110-c. The STA 110-b is shown as receiving multiple interfering signals 210-a, 210-b, 210-c, and 210-d from the STA 110-c. The interfering signals 210 are shown as separate signals for purposes of illustration only, and it is to be understood that more or less interfering signals 210 may be received at the STA 110-b or that the interfering signals 210 may be longer or continuous signals. In some other implementations, the STA 110-b experiences interference from other, and perhaps multiple, sources. Such signals may cause interference with a packet sent from the AP 105-a to the STA 110-b.

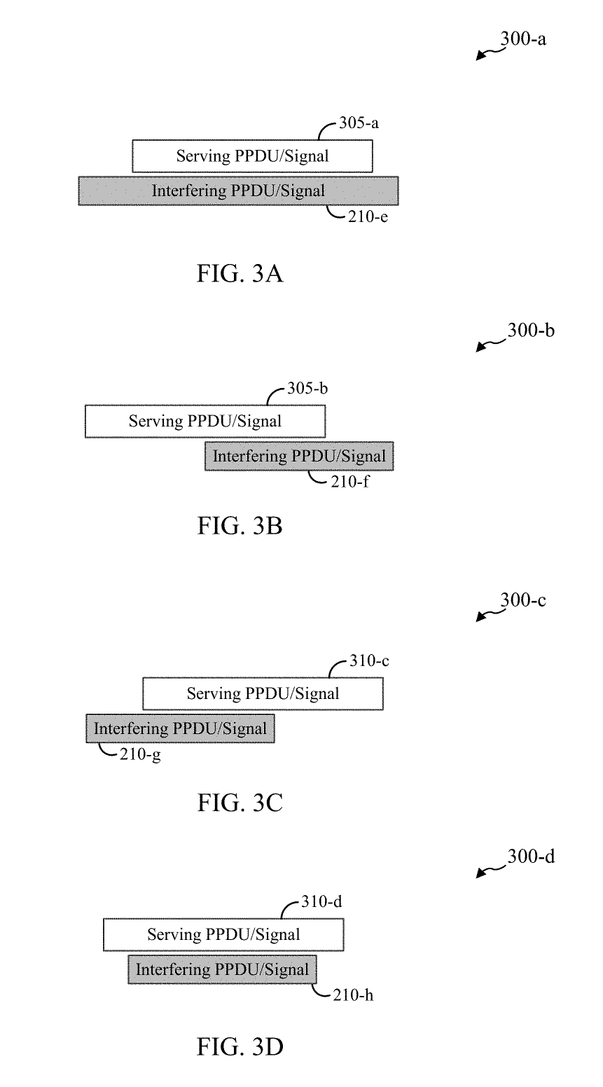

As described, Wi-Fi is an asynchronous system. Interference may be present before a packet is detected or appear after a packet is detected. Interference may have a variable length and may affect a part of the serving PLCP protocol data unit (PPDU). Turning briefly to FIGS. 3A-3D, examples of interfering signals 210 overlapping with desired signals are provided. FIGS. 3A-3D show block diagrams 300-a, 300-b, 300-c, and 300-d, respectively, which illustrate examples of packets and interfering signals received at a wireless device, such as the STA 110-b of FIG. 2. The PPDU 305-a, 305-b, 305-c, and 305-d correspond to the signals intended for the STA 110-b. These represent the non-interfering, desired signals.

FIG. 3A provides an example in which the interference overlaps with the entire desired signal. That is, the interfering PPDU or interfering signal 210-e is present during the entire serving PPDU (signal 305-a). FIG. 3B illustrates an example in which the interfering PPDU (interfering signal 210-f) is present after the serving PPDU (signal 305-b) begins to be transmitted or received. FIG. 3C illustrates an example in which the interfering PPDU (interfering signal 210-g) precedes transmission or reception of the serving PPDU (signal 305-c). Finally, FIG. 3D illustrates an example in which the interfering PPDU or interfering signal 210-h begins after the serving PPDU (signal 305-d) begins to be transmitted or received and ends before the serving PPDU (signal 305-d) completes. Of course, the interference in any given situation may be more complicated than these illustrated cases. For example, the interference may start and stop multiple times during the serving PPDU (signal 305). Additionally, multiple interfering signals may be present. As used throughout this description, a single interfering signal describes the composite interference that is received at the receiver (such as the STA 110-b), regardless of whether there are multiple sources.

Returning to FIG. 2, the STA 110-b may perform a channel estimate. The channel estimate may be performed at any time. In some other implementations, the STA 110-b performs the channel estimate before the interference estimate is determined and uses the channel estimate in the determination of the interference estimate. In some other implementations, the STA 110-b may perform the channel estimate before the STA 110-b updates its interference filter.

As FIG. 2 is describing post-detection interfering nulling techniques, the STA 110-b may detect a first portion of a packet 215. This first portion of the packet 215 may be transmitted by the AP 105-a. In some other implementations, the first portion of the packet 215 is transmitted by another STA 110. The AP 105-a may transmit a first portion of a packet 215 to the STA 110-b.

In Wi-Fi networks, the STA 110-b has to detect each packet separately at a receiver of the STA 110-b. A packet preamble may include a legacy short training field (L-STF), a legacy long training field (L-LTF), a legacy signal field (L-SIG), a short training field (STF), one or more long training fields (LTFs), and one or more signal fields (SIG). The packet also may include a payload after the preamble. A packet may be detected by its preamble, which may include a known non-zero portion.

The STA 110-b has detected a first portion of the packet at block 220, but the detection may have occurred before an STF of the packet was detected or after it was detected. That is, the STA 110-b may perform interference nulling before the STF or after the STF is detected. An STF symbol may contain multiple periodic signals in time. In some implementations, the STA 110-b detects a packet by correlating a first STF symbol of a preamble of the packet with another one of the STF symbols. The correlated symbols may be from one period to the next. By correlating the repeated symbols, the STA 110-b may detect if an STF signal is present. In some implementations, if the interference is too great during transmission of the STF preamble portion of the packet, the STA 110-b may not detect the packet.

Performing interference nulling before the STF is detected (pre-STF detection nulling) may enhance the detection performance in the presence of interference. That is, the STA 110-b may be more likely to detect a packet using the interference nulling techniques described herein. In some implementations, packet detection pre-STF is done in the time domain and thus detection algorithms operate in the time domain. In the pre-STF detection, interference estimation may be known before the PPDU is detected.

Performing interference nulling after the STF is detected (post-STF detection nulling) may allow the known PPDU structure to be exploited for interference estimation. Detecting a packet after the STF (such as by an LTF or an SIG field) may assume the packet is detected correctly, which implies the signal-to-interference noise ratio (SINR) is greater than the detection threshold. The STA 110-b may perform the interference nulling as soon as the L-SIG is detected, which may enhance the detection performance of the SIG fields. In some other implementations, the post-detection frequency nulling may start at or directly before the payload. In such a case, the STA 110-b may assume a conservative SINR to ensure detection. The STA 110-b may perform interference nulling in the post STF detection scenarios in either the frequency or time domain.

At block 225, the STA 110-b estimates interference based on the known non-zero portion of the first portion of the packet 215. In some implementations, the STA 110-b may include a new processing block in the frequency domain to estimate the channel and interference as described herein. In some implementations, estimation of the interference may happen concurrently with the reception of the desired PPDU (the first portion of the signal and the second portion of the signal 235. The STA 110-b may exploit training symbols of the desired PPDU or perform a blind estimation. This estimation may be sufficient for post-detection nulling. In another implementation, estimation of interference may happen before the reception of the desired PPDU, as may be the case in the pre-detection solutions discussed herein. In this case, the interference estimation may be based on one or more of continuous asynchronous measurement of the channel energy, detection of interfering PPDUs (such as all PPDUs with different colors, or beacons), periodic reference signals explicitly sent for the purpose of interference nulling, and record interference measured concurrently with previously received desired PPDUs. The periodic reference signals may be in the form of midambles. Midambles may include reference signals transmitted between a beginning and an end of a packet or frame.

The interference estimation may be based on algorithms that work with existing standing waveforms. This may allow for receiver-only situations and may present unique problems because the waveforms were not designed for IN. These techniques also may be applied to single-user or multi-user PPDUs. Some techniques work with existing standard media access control (MAC) asynchronous transmissions with no schedule. Because there is no schedule, the STA 110-b has no prior knowledge of who the interferer is and where the interference is coming from.

For estimating interference that is already present at the start of the packet 215, a joint channel and interference estimation may be used. This may entail the STA 110-b performing enhanced processing of the LTFs of the preamble of the packet 215. The STA 110-b may exploit any other known or redundant pattern of the preamble to improve the estimation. For example, the STA 110-b may use, in alternative or in addition, a portion of the STF after the automatic gain control (AGC) settling or decoding and re-encoding of the SIG fields.

Example notation for one technique is provided. The variable X(s,t) may denote a transmitted signal on a tone, t, at a symbol, s. The variable H(s,t) may denote a channel at tone t and at symbol s. The variable Y(s,t) may denote a received signal at the antennas of STA 110-b, at tone t and at symbol s. The variable I(s,t) may denote received interference at the antennas, at tone t and at symbol s. The sample covariance between X(1:s,t) and Y(1:s,t) is denoted as R_{YX}(s,t) and is given in Equation 1:

$${R}_{YX} ( s , t ) = 1 / ( s ) {\sum }_{i = 1}^{i = s} Y ( i , t ) {X ( i , t )}^{′} \qquad ( 1 )$$

The sample autocovariance of X(1:s,t) is denoted as R_{XX} (s,t) and is given in Equation 2:

$${R}_{XX} ( s , t ) = 1 / ( s ) {\sum }_{i = 1}^{i = s} X ( i , t ) {X ( i , t )}^{′} \qquad ( 2 )$$

The sample autocovariance of Y(1:s,t) is denoted as R_{YY}(s,t) and is given in Equation 3:

$${R}_{YY} ( s , t ) = 1 / ( s ) {\sum }_{i = 1}^{i = s} Y ( i , t ) {Y ( i , t )}^{′} \qquad ( 3 )$$

To perform channel estimation based on high efficiency (HE) LTFs, it may be assumed that s=1 corresponds to the first LTF, s=2 corresponds to the second LTF, and so on. It also may be assumed that the t index spans all tones where known symbols are transmitted. Thus, the channel at tone t and symbol s may be given as in Equation 4:

Ĥ(s,t)=R_{YX}(x,t)·pinv(R_{XX}(x,t)) (4)

The estimation of the interference covariance based on L-LTFs may be denoted as [symbol] (s,t) and given as in Equation 5:

[symbol]

(s,t)=R_{YY}−Ĥ(s,t)·R′_{yx} (5)

The same procedure can be used to jointly estimate channel and interference from any tone for which the transmitted signal is known and non-zero, by including them in the covariance estimates. If the code supports decoding and re-encoding of any SIG field, include the corresponding X, Y signals into the covariance computation. In some implementations, the pilot signals may be too spread apart for a reliable estimation. The STF populated tones may be used.

The STA 110-b may apply rank augmentation or smoothing to the interference estimate. The estimation of [symbol] may be very noisy if not enough samples are averaged. Moreover, a linear receiver with N antennas can resolve N spatial dimensions and needs at least N observations of the received signal to resolve them. A legacy preamble may provide two LTF symbols that may allow the STA 110-b to resolve two streams (such as one serving and one interfering). In some implementations, a VHT/HE preamble may provide a single LTF per spatial stream in the worst case, which may not be sufficient to resolve multiple interference directions.

Fortunately, [symbol] is a smooth function in frequency (which may be around the interfering channel). Neighboring tones can provide independent observations of substantially the same [symbol] instance. This may allow for increasing the rank of the observation and improving the averaging of the [symbol] samples. A smoothing operation may be performed so as to preserve the properties of a covariance matrix. A simple average may work well and may be used for a first pass or phase. In some implementations, a factor of N=5 may be used for the tested channel. In some other implementations, the channel may be smoothed separately.

The smoothing of [symbol] and [symbol] may be given as in Equations 6 and 7:

$$\begin{matrix} ( s , t ) = {\sum }_{i = circ ( s - N )}^{i = circ ( s + N )} \hat{R} yx ( i , t ) & ( 6 ) \\ ( s , t ) = {\sum }_{i = circ ( s - N )}^{i = circ ( s + N )} \hat{R} yy ( i , t ) & ( 7 )\end{matrix}$$

In some other implementations, other smoothing operations may be used. For example, the STA 110-b may use time domain smoothing. The STA 110-b may apply an inverse fast Fourier transform (FFT) to the interference estimate, then truncate the time domain coefficients before converting back to frequency domain using a FFT. This approach may be applied to both channel estimates as well as covariance matrices. In another implementation, the STA 110-b may use Cholesky smoothing on the covariance matrix. First, the STA 110-b may use the Cholesky decomposition R=UU′, where U is an upper diagonal matrix. Then, the STA 110-b may smooth U either via a time domain or a frequency domain smoothing approach. The STA 110-b may then reconstruct R from the smoothed U.

Once the interference estimate is developed and potentially smoothed, the STA 110-b may use it to null the interference received at the STA 110-b at block 230. In some implementations, the nulling operation may be performed in the frequency domain. Per each tone k (omitting the subscripts), a minimum-mean square error (MMSE) nulling filter, W, may be computed according to Equation 8:

W=pinv(ĤĤ′+ [symbol] )Ĥ (8)

The nulling operation may be performed as in Equation 9:

\hat{X}=W′Y (9)

Post MMSE noise covariance (for log-likelihood ratio (LLR) slicing) is provided in Equation 10 and post MMSE SINR for each spatial stream is given in Equation 11:

$$\begin{matrix}{R}_{e} = E \{ {\vert X - \hat{X} \vert}^{2} \} = {R}_{XX} - {W}^{′} {R}_{yx} & ( 10 ) \\ SINR ( ss ) = \frac{1}{diag ( {R}_{e} )} & ( 11 )\end{matrix}$$

In some implementations, the nulling operation is a linear equation, hence W has at least a rank equal or greater than the sum of the data streams plus the interfering streams. Because the nulling operation is a linear equation in this example, the number of training symbols in the estimation of H(s,t) and [symbol] may be greater than or equal to the number of the data streams plus the interfering streams. In some implementations, rank augmentation techniques also may be used which allow the rank of W to be increased from a rank deficient training.

The STA 110-b may calibrate the filter to remove any minimum mean square error (MMSE) interference nulling filter bias. The MMSE interference nulling filter may use channel and interference covariance matrices estimated from a limited number of signal (such as training symbols) observations. The MMSE interference nulling filter may be linear. The channel smoothing process also may introduce bias to the channel and covariance matrices. In order to compensate for any bias, the STA 110-b may introduce a calibration factor. This calibration factor may be added to the diagonal entries of [symbol] . The calibration factor may be a function of one or more of MCS, a noise variance, and an interference-to-noise ratio (INR). The INR may be estimated from either a L-LTF or a HE-STF once the noise variance is estimated.

There are several ways the noise variance may be estimated. For example, the noise variance may be estimated using a time domain approach. An IFFT of the channel estimated may be performed and the noise power may be averaged from a filter with the least energy (such as a 64 tap filter).

The MMSE without IN, denoted W_{noIN}, may need knowledge of interference and noise power for the filter calculation. Rᵢᵢ may be replaced by a diagonal matrix scaled by the interference and noise power as shown in Equation 12, where the noise power level (including thermal, PN, PA, etc.) is given as Nₒ and the interference power level (from any interfering wireless devices) is given as Nᵢ:

W_{noIN}=pinv(ĤĤ′+I_{Ns}*(Nₒ+Nᵢ))Ĥ (12)

In some cases, the estimation of Nₒ+Nᵢ is from two consecutive symbols in the L-LTF signal and may be given as in Equation 13:

$${N}_{o} + {N}_{i} = E \frac{\{ {\vert {Y}_{LLTF 2} - {Y}_{LLTF 1} \vert}^{2} \}}{2} \qquad ( 13 )$$

The averaging may be performed over all L-LTF populated tones. In some implementations, an enhanced estimation of Nₒ+Nᵢ may be achieved from using null tones of HE-STF. HE-STF may have unpopulated tones (such as 3 out of 4 tones; or 7 out of 8 tones depending on the HE-STF duration). The null tones may be used to estimate interference and noise power. In some implementations, this process similarly may be applied to the L-STF.

The interference plus noise power level (using null tones of HE-STF) may be provided as in Equation 14:

Nₒ+Nᵢ=Σ_{k=nullTones}|Y_{HE-STF}(k)|²//nullTones/ (14)

The null tones may be indexed depending on the HE-STF signal part used for noise and variance estimation. A default duration may be short, such as 8 μs. In some other implementations, other durations may be used.

In this manner, a wireless device may improve throughput gains and reduce interference. Interference at the receiver may be reduced using these techniques after an initial portion of a packet is detected. The STA 110-b may apply the interference nulling and then receive the rest of the packet, such as the second portion of the packet 235.

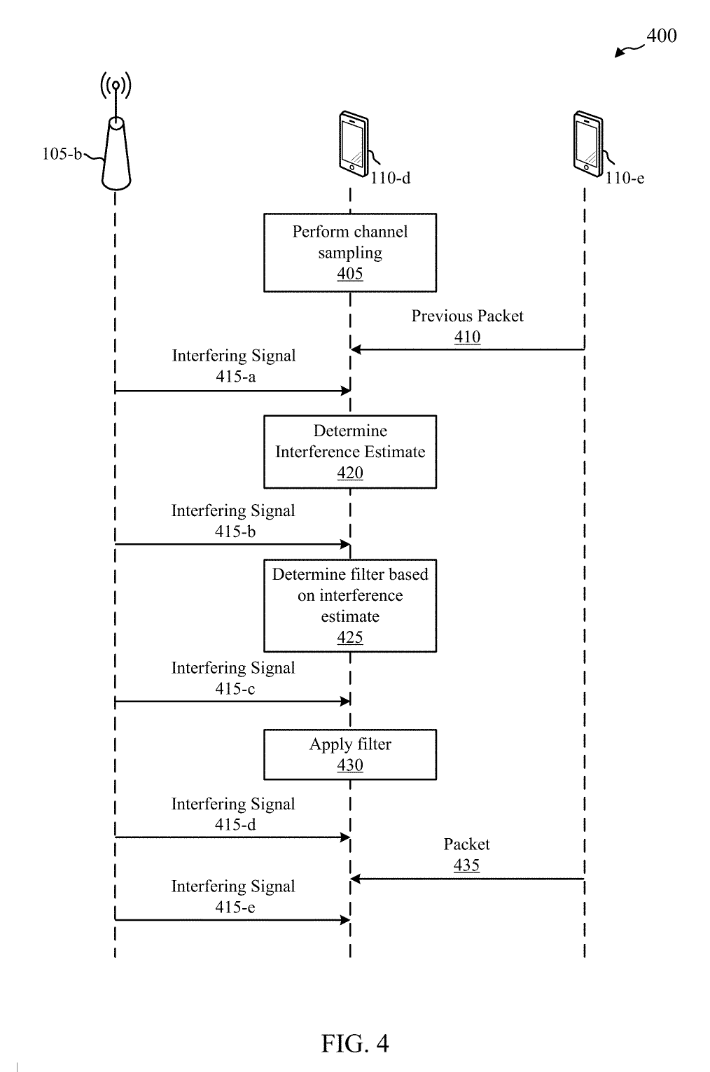

FIG. 4 shows a swim diagram illustrating another example of a process 400 of nulling interference at a wireless device. The process 400 includes a STA 110-d, an AP 105-b, and another STA 110-e. The STAs 110-d and 110-e may be an example of one or more aspects of the STAs 110 of FIGS. 1 and 2. The AP 105-b may be an example of one or more aspects of the AP 105 described with reference to FIGS. 1 and 2. Although this example illustrates the STA 110-d performing the interference nulling techniques, the AP 105-b also may perform these techniques. FIG. 4 illustrates pre-detection interference nulling techniques. That is, the STA 110-d applies the nulling techniques before detecting or receiving the data packet.

As shown, the STA 110-d is within communication range of the AP 105-b and the STA 110-e. The STA 110-d is shown as receiving multiple interfering signals 415-a, 415-b, 415-c, and 415-d from the AP 105-b. The interfering signals 415 are shown as separate signals for purposes of illustration only, and it is to be understood that more or less interfering signals 415 may be received at the STA 110-d or that the interfering signals 415 may be longer or continuous signals. In some other implementations, the STA 110-d experiences interference from other, and perhaps multiple, sources. Such signals may cause interference with a packet sent from the STA 110-e to the STA 110-d.

At block 405, the STA 110-d performs channel sampling. Nulling interference before detecting a data packet may use a priori knowledge of at least one of the single stream channel of the STA 110-d or interference. The single stream channel can set a filter to at least match the desired direction and allow it to estimate the interference. The knowledge of the STA 110-d's own channel may be based on earlier detected packets, such as previous packet 410. However, the channel may change over time. In a downlink, the STA 110-d has many downlink packets it can use for estimation (beacon, any downlink data, etc.). If a new MAC is defined, the channel estimate at the STA 110-d may include periodic reference signals at known arrival times. For example, the STA 110-e may transmit periodic reference signals at known arrival times to the STA 110-d. For the AP side to use periodic reference signals, numbers of channels may be stored.

At block 420, the STA 110-d may determine an interference estimate. The interference may be used to build a null-space filter that rejects the interference and keeps the noise while the STA 110-d waits for a data packet. The STA 110-d may use the channel knowledge to determine that the estimated signal is interference and not a desired signal.

At block 425, the STA 110-d determines a null filter based on the interference estimate. Since the interfering channel is estimated, the filter may be constructed as a 1-dimensional null space filter associated to the eigenvector of the smallest eigenvalue. In another implementation, dimension n may be used based on a threshold and the on lowest n eigenvalues. [symbol] may be provided as in Equation 15:

$${R}_{II} = [ \begin{matrix}{R}_{II}^{0 , 0} & … & {R}_{II}^{0 , T} \\ ⋮ & ⋱ & ⋮ \\ {R}_{II}^{T , 0} & … & {R}_{II}^{T , T}\end{matrix} ] \qquad ( 15 )$$

Where R_{II}^{t1,t2} is the spatial covariance of the received signal across antennas, where the received signal includes T samples, and the covariance is calculated between two versions of the signal, shifted by t1 and t2 respectively. In some implementations, USU′=SVD(R_{II}) and the filter may equal the column of U corresponding to the smallest singular value in S. The matrix U may be a unitary matrix, the matrix S may be a diagonal matrix, and S′ may be a complex conjugate matrix of S. In one case, an interfering channel may be assumed to be 1-tap, which results in one scaling factor used per antenna.

At block 430, the STA 110-d applies the null filter to the channel. The null filter may reduce the interference experienced at the STA 110-d. The packet 435 may be received at the STA 110-d. The STA 110-d may experience less interference during reception of the packet 435 due to applying the null filter.

In some implementations, the STA 110-d detects whether interference is present and uses the IN processing if the interference meets or exceeds a threshold level. In some implementations, detection of the presence of interference may be based on an energy of Rᵢᵢ, a ratio of energy of the diagonal and off-diagonal elements of the Rᵢᵢ, and if an interfering packet is detected and the length of the interfering packet is known.

In some implementations, the decomposition of the interference may be simplified. In such an example, the filter may be adaptive and quantized. This may be achieved by estimating the Rᵢᵢ, applying one of N pre-defined nulling filters, and estimating the energy of the output (the energy of the residual interference). If the estimate is lower, the new filter may be kept and used, otherwise the earlier filter or another filter may be used.

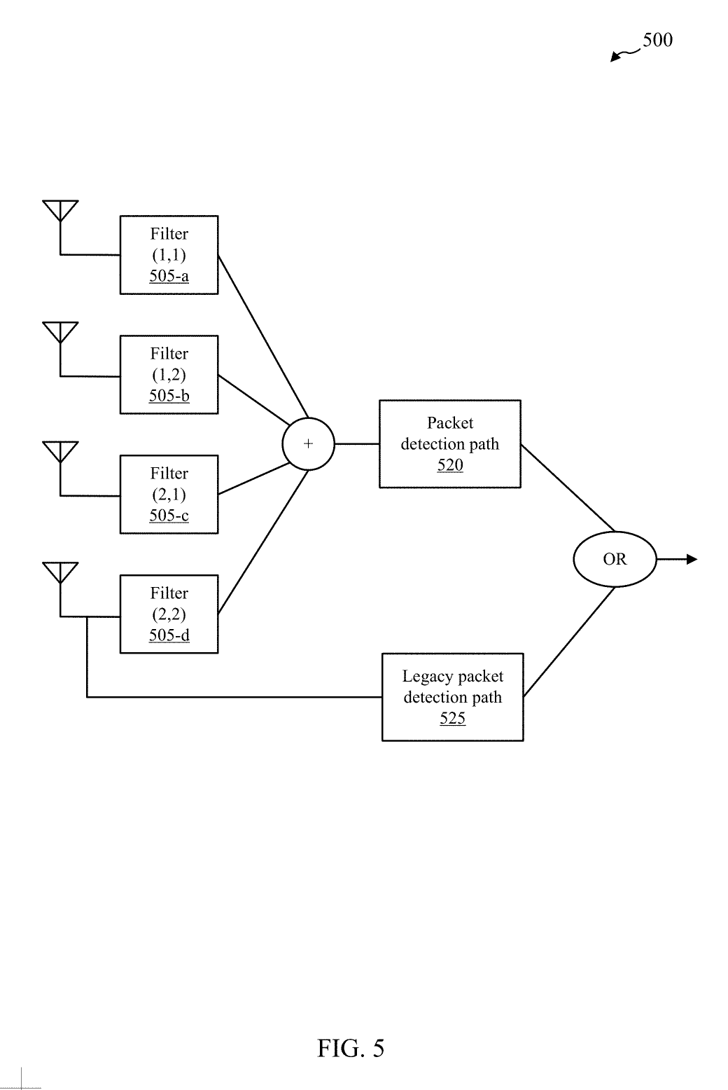

FIG. 5 shows a block diagram illustrating an example of a pre-detection nulling architecture 500 that supports interference nulling for Wi-Fi frequency domain processing. The diagram illustrates dedicated nulling for a packet detector path and a legacy packet detection path. In some implementations, the pre-detection nulling architecture 500 is incorporated into a STA 110 or an AP 105 that performs the interference nulling techniques described herein.

The pre-detection nulling architecture 500 includes four receive chains and filters 505-a, 505-b, 505-c, and 505-d. The filters may be summed and provided along a packet detection path 520. As long as a packet is detected, interference nulling for the data can be performed by current post-detection frequency domain or a similar time domain version.

In some situations, the application of a nulling filter in case of absence of interference may result in a loss of performance. In one example, both a legacy packet detection path 525 may be used in conjunction with the packet detection path 520. The legacy packet detection path 525 may be coupled to one or more antennas of the STA 110 or AP 105. Using this architecture, both of the packet detection paths may be used and an OR operation may be applied to the detection output. That is, either path may detect a packet.

In some implementations, the interference nulling in the data path described earlier also may be cascaded with the post-detection nulling. In some other implementations, there may be a filter that performs the interference nulling for packet detection which is cascaded with a data-path nulling filter.

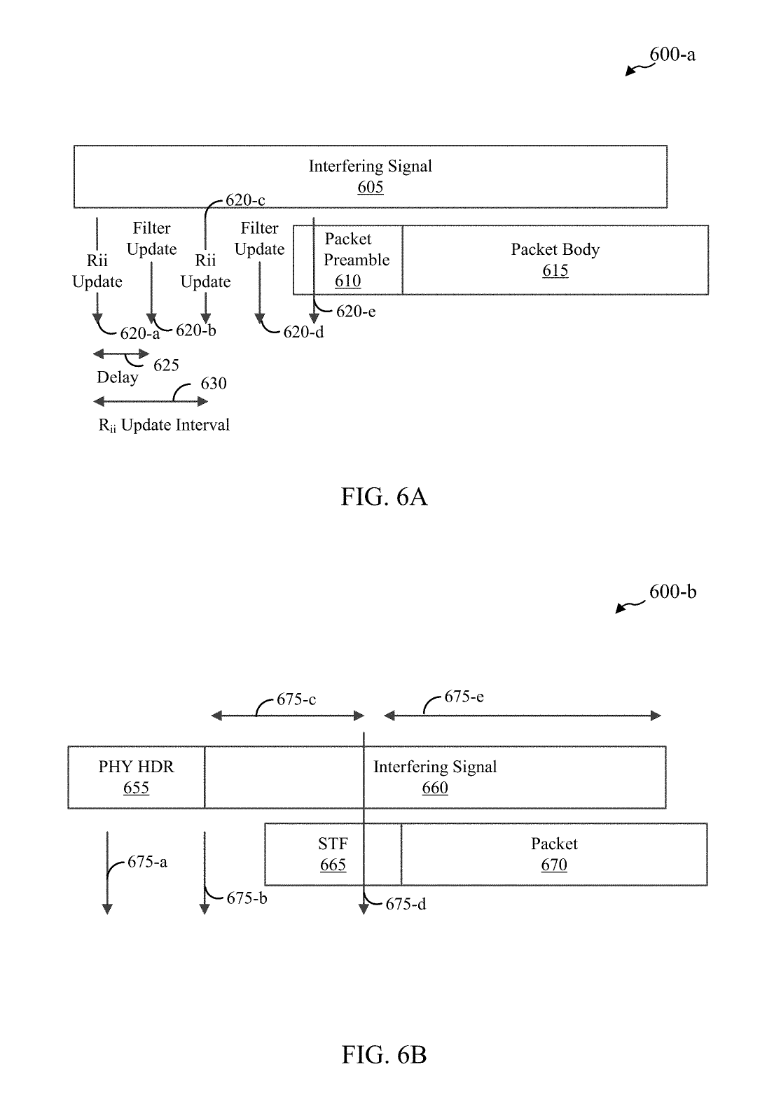

FIGS. 6A-6B show block diagrams 600-a and 600-b illustrating examples of packets and interfering signals received at a wireless device. FIGS. 6A-6B show various times where a receiver (such as in a STA 110 or AP 105) performing nulling interference takes specific actions in comparison to the times of the interference and the data packet arrival.

In FIG. 6A, an interfering signal 605 may be present before a packet is detected. The packet may include a preamble portion 610, containing for example an STF, and a packet body portion 615. In this example, the receiver periodically “blindly” estimates the Rᵢᵢ from over-the-air (OTA) sampling. The estimates may be frequency dependent for certain power consumption levels. The receiver may update Rᵢᵢ update every Rᵢᵢ update interval 630, such as at times 620-a and 620-c. The receiver may periodically update the nulling filter at times 620-b and 620-d, after a delay 625 from the latest Rᵢᵢ update. At time 620-e, the receiver may detect the preamble portion 610 of the packet.

In FIG. 6B, an interfering signal 660 includes a physical header (PHY HDR) 655. The packet 670 also may include a STF preamble portion 665. At time 675-a, the receiver detects the interfering signal 660, which may be a PPDU from an overlapping BSS. At time 675-b, the receiving device (such as the STA 110 or AP 105) stores an interference channel estimate and drops the interfering signal 660. During time 675-c, the receiving device may apply interference nulling based on the interference channel estimate (which may be in the time domain). At time 675-d, the receiving device may detect its own packet, packet 670. During time 675-e, the receiving device may apply the nulling filter based on the current signal channel estimate and a current interference channel estimate (which may be in the frequency domain). In some implementations, if the estimated interference is also used for the data portion of the packet 670, a frequency offset may be compensated.

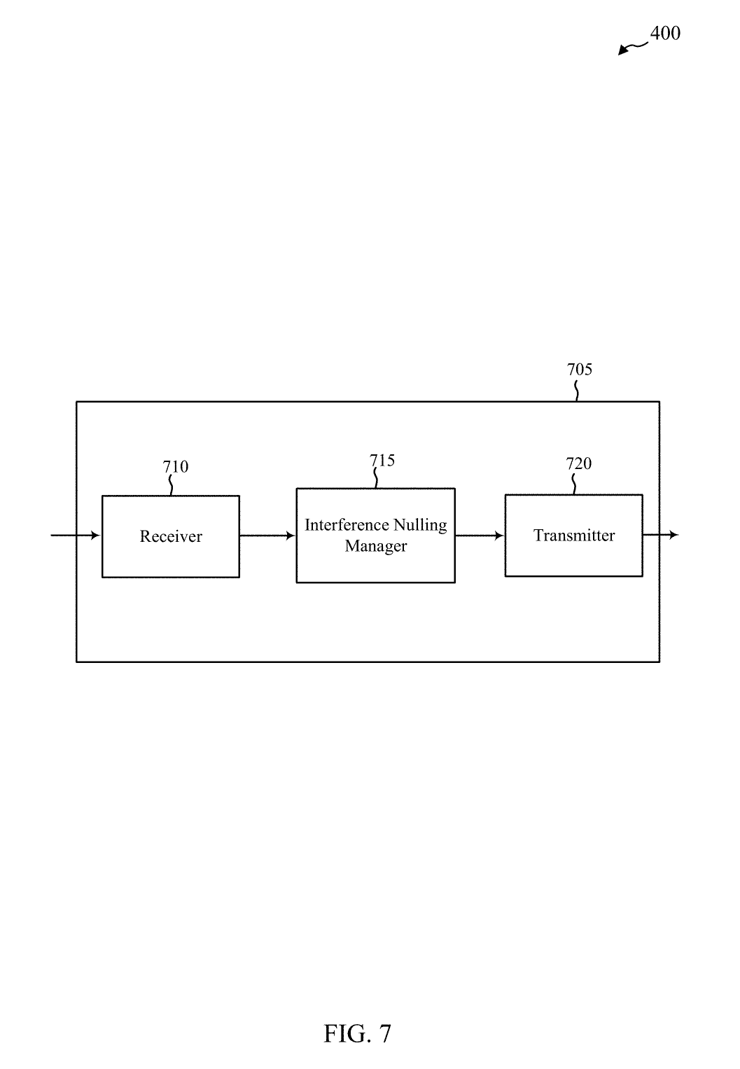

FIG. 7 shows a block diagram 700 of a wireless device 705 that supports interference nulling for Wi-Fi frequency domain processing. The wireless device 705 may be an example of aspects of a STA 110 or an AP 105 as described with reference to FIG. 1. The wireless device 705 may include a receiver 710, an interference nulling manager 715, and a transmitter 720. The wireless device 705 also may include a processor. Each of these components may be in communication with one another (such as via one or more buses).

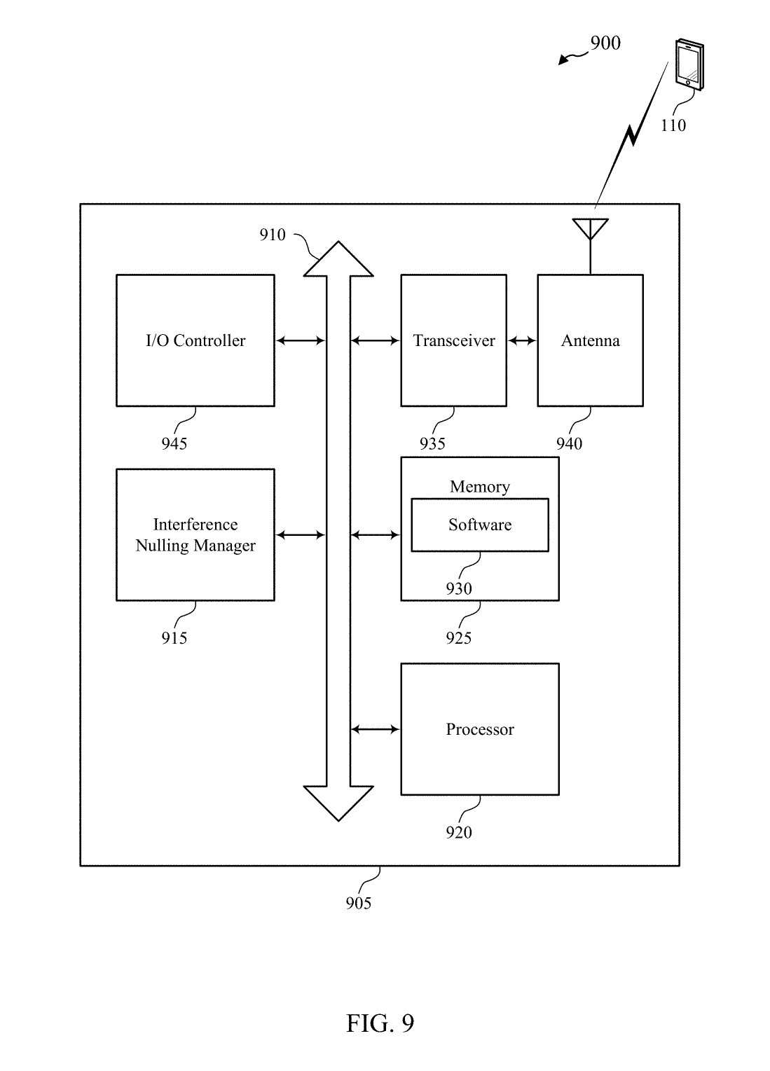

The receiver 710 may receive information such as packets, user data, or control information associated with various information channels (such as control channels, data channels, and information related to interference nulling for Wi-Fi frequency domain processing, etc.). Information may be passed on to other components of the wireless device 705. The receiver 710 may be an example of aspects of the transceiver 935 described with reference to FIG. 9.

The interference nulling manager 715 may be an example of aspects of the interference nulling managers 130 and 140 described with reference to FIG. 1 and the interference nulling manager 915 described with reference FIG. 9.

The interference nulling manager 715 or at least some of its various sub-components may be implemented in hardware, software executed by a processor, firmware, or any combination thereof. If implemented in software executed by a processor, the functions of the interference nulling manager 715 or at least some of its various sub-components may be executed by a general-purpose processor, other logic component, or any combination thereof designed to perform the functions described in the present disclosure. The interference nulling manager 715 or at least some of its various sub-components may be physically located at various positions, including being distributed such that portions of functions are implemented at different physical locations by one or more physical devices. In some implementations, the interference nulling manager 715 or at least some of its various sub-components may be a separate and distinct component in accordance with various aspects of the present disclosure. In some other implementations, the interference nulling manager 715 or at least some of its various sub-components may be combined with one or more other hardware components, including but not limited to an I/O component, a transceiver, a network server, another computing device, one or more other components described in the present disclosure, or a combination thereof in accordance with various aspects described herein.

The interference nulling manager 715 may detect at least a first part of an unscheduled Wi-Fi packet transmitted over a Wi-Fi channel. The interference nulling manager 715 also may perform a channel estimation on the Wi-Fi channel, estimate an interference on the Wi-Fi channel based on a known non-zero portion of the preamble of the Wi-Fi packet, and null interference from the Wi-Fi channel during reception of at least a second part of the Wi-Fi packet based on the channel estimate and the estimated interference. The interference nulling manager 715 also may determine an interference estimate based on at least one of a previously received packet or channel sampling for a Wi-Fi channel, compute a filter based on the interference estimate, and apply the filter to a received signal to null interference on the Wi-Fi channel at least before detection of a Wi-Fi packet.

The transmitter 720 may transmit signals generated by other components of the device. In some implementations, the transmitter 720 may be collocated with a receiver 710 in a transceiver module. For example, the transmitter 720 may be an example of aspects of the transceiver 935 described with reference to FIG. 9. The transmitter 720 may include a single antenna, or it may include a set of antennas.

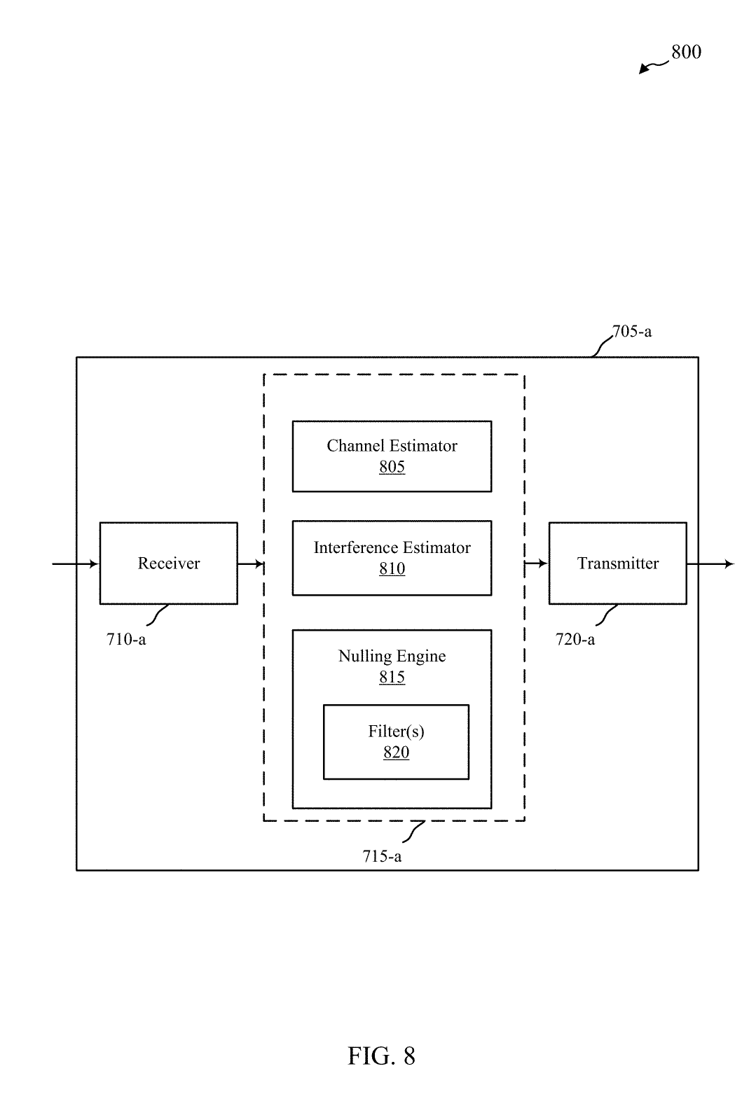

FIG. 8 shows a block diagram 800 of a wireless device 705-a that supports interference nulling for Wi-Fi frequency domain processing in accordance with various aspects of the present disclosure. The wireless device 705-a may be an example of aspects of a wireless device 705 or a STA 110 or AP 105 as described with reference to FIGS. 1 and 7. The wireless device 705-a may include a receiver 710-a, an interference nulling manager 715-a, and a transmitter 720-a. The wireless device 705-a also may include a processor and memory. Each of these components may be in communication with one another (such as via one or more buses).

The receiver 710-a may receive information such as packets, user data, or control information associated with various information channels (such as control channels, data channels, and information related to interference nulling for Wi-Fi frequency domain processing, etc.). Information may be passed on to other components of the wireless device 705-a. The receiver 710-a may be an example of aspects of the transceiver 935 described with reference to FIG. 9.

The interference nulling manager 715-a may be an example of aspects of the interference nulling managers 130 and 140 described with reference to FIG. 1 and the interference nulling manager 915 described with reference to FIG. 9. The interference nulling manager 715-a also may include a channel estimator 805, an interference estimator 810, and a nulling engine 815.

The channel estimator 805 may detect at least a first part of an unscheduled Wi-Fi packet transmitted over a Wi-Fi channel and perform a channel estimation on the Wi-Fi channel during a known non-zero portion of the packet. In some cases, the first part of the data packet is a preamble of the packet or a component of the preamble (such as a STF or LTF), and the known non-zero portion of the preamble includes the STF or the LTF of the preamble. In some cases, the known non-zero portion of the preamble corresponds to a portion of the STF received after AGC settling and decoding or re-encoding of a signal field at the receiver 710-a.

The interference estimator 810 may estimate an interference on the Wi-Fi channel based on the known non-zero portion of the preamble of the Wi-Fi packet and perform a smoothing operation on the Wi-Fi channel or the interference estimate in the frequency domain. The smoothing operation may be calibrated based on an MCS of the Wi-Fi packet, an SINR of the Wi-Fi channel, a number of receive antennas used by the wireless device 705-a The interference estimator 810 also may determine an interference estimate based on at least one of a previously received packet or channel sampling for a Wi-Fi channel. In some implementations, the interference estimator 810 periodically determines the interference estimate via over the air sampling, and detects interference on the Wi-Fi channel based on at least one of: an energy level received at a receive chain or a ratio of energy of diagonal to energy of off-diagonal elements of the receive chain, or on detection of an interfering packet with a known length. In some cases, the interference estimate is based on a known or redundant waveform of the known non-zero portion of the preamble of the Wi-Fi packet.

The nulling engine 815 may null interference from the Wi-Fi channel during reception of at least a second part of the Wi-Fi packet based on the channel estimate from the channel estimator 805 and the estimated interference from the interference estimator. The nulling engine 815 may use one or more filters 820 to null the interference. In some implementations, the nulling engine 815 may, upon detection of a Wi-Fi packet, apply null-space filters 820 to null at least some of the interference on the Wi-Fi channel while keeping at least some noise. That is, the interference nulling may not completely remove all noise from the channel. In some implementations, some noise may be left on the channel, which may aid in the detection of the Wi-Fi packet.

The nulling engine 815 also may compute a filter 820 based on the estimated channel or interference estimate, and apply the filter 820 to a received signal to null interference on the Wi-Fi channel at least before detection of a Wi-Fi packet. In some implementations, the filter 820 may be applied to the received signal in the absence of a detected legacy WiFi packet. Additionally or alternatively, the filter 820 may be applied in response to or otherwise based on a detection of an overlapping BSS PPDU. In some other implementations, the filter 820 may be applied to the received signal in response to or otherwise based on at least one of: an absence of a determination that a packet was detected or an absence of a determination that an interference level is below a threshold interference level. In some cases, nulling interference from the Wi-Fi channel further includes applying the filter 820 to a received signal during reception of at least a second part of the Wi-Fi packet. The second part of the Wi-Fi packet may include the body of the packet or a portion of the packet following the known non-zero portion of the preamble. The filter 820 may in some implementations be activated before it is applied to the received signal. For example, when the interference characteristics do not change fast, a fixed or slowly updated nulling filter can be used before the next signal arrives.

The transmitter 720-a may transmit signals generated by other components of the device. In some implementations, the transmitter 720-a may be collocated with the receiver 710-a in a transceiver module or circuit. For example, the transmitter 720-a may be an example of aspects of the transceiver 935 described with reference to FIG. 9. The transmitter 720-a may include a single antenna, or it may include a set of antennas.

FIG. 9 shows a diagram of a system 900 including a wireless device 905 that supports interference nulling for Wi-Fi frequency domain processing. The wireless device 905 may be an example of or include the components of the wireless device 705, the wireless device 705-a, or the STA 110 or AP 105, such as with reference to FIGS. 1, 2, 4, 7 and 8. The wireless device 905 may include components for bi-directional voice and data communications including components for transmitting and receiving communications, including an interference nulling manager 915, a processor 920, a memory 925, software 930, a transceiver 935, one or more antennas 940, and an I/O controller 945. These components may be in electronic communication via one or more busses (such as the bus 910).

The processor 920 may include a programmable hardware device, (such as a general-purpose processor, a DSP, a CPU, a microcontroller, an ASIC, an FPGA, a programmable logic device, a discrete gate or transistor logic component, a discrete hardware component, or any combination thereof). In some cases, the processor 920 may be configured to operate a memory array using a memory controller. In other cases, a memory controller may be integrated into the processor 920. The processor 920 may be configured to execute computer-readable instructions stored in a memory to perform various functions (such as functions or tasks supporting interference nulling for Wi-Fi frequency domain processing).

The memory 925 may store software 930 that is computer-readable and computer-executable, such as software 930 including instructions that, when executed, cause the processor 920 to perform various functions described herein. The software 930 may include code to implement aspects of the present disclosure, including code to support interference nulling for Wi-Fi frequency domain processing. The software 930 may be stored in a non-transitory computer-readable medium such as system memory or other memory. In some cases, the software 930 may not be directly executable by the processor but may cause a computer, when compiled and executed, to perform functions described herein.

The transceiver 935 may communicate bi-directionally, via one or more antennas, wired, or wireless links. For example, the transceiver 935 may represent a wireless transceiver and may communicate bi-directionally with another wireless transceiver. The transceiver 935 also may include a modem to modulate the packets and provide the modulated packets to the antennas for transmission, and to demodulate packets received from the antennas.

In some cases, the wireless device 905 may include a single antenna 940. However, in some cases the device may have more than one antenna 940, which may be capable of concurrently transmitting or receiving multiple wireless transmissions.

The I/O controller 945 may manage input and output signals for wireless device 905. The I/O controller 945 also may manage peripherals not integrated into wireless device 905. In some cases, the I/O controller 945 may represent a physical connection or port to an external peripheral. In some cases, the I/O controller 945 may utilize an operating system such as iOS®, ANDROID®, MS-DOS®, MS-WINDOWS®, OS/2®, UNIX®, LINUX®, or another known operating system. In some other cases, the I/O controller 945 may represent or interact with a modem, a keyboard, a mouse, a touchscreen, or a similar device. In some cases, the I/O controller 945 may be implemented as part of a processor. In some cases, a user may interact with the wireless device 905 via I/O controller 945 or via hardware components controlled by I/O controller 945.

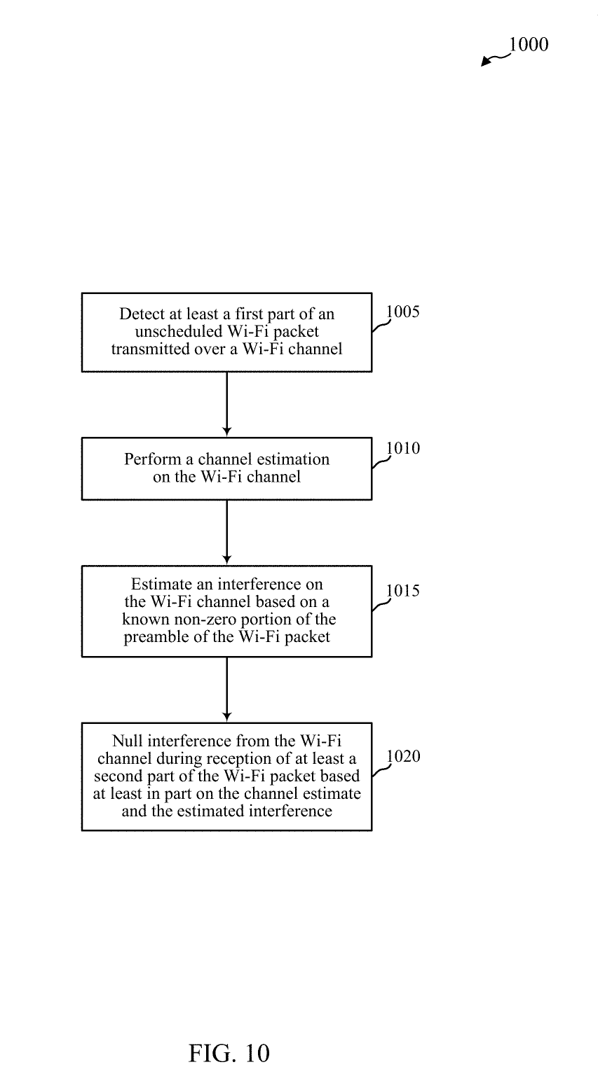

FIG. 10 is a flow chart illustrating an example of a method 1000 for post-detection interference nulling. The operations of the method 1000 may be implemented by a STA 110 or AP 105 or its components as described herein. For example, the operations of the method 1000 may be performed by an interference nulling manager as described with reference to FIGS. 1, and 7-9. In some implementations, a STA 110 or an AP 105 may execute a set of codes to control the functional elements of the device to perform the functions described below. Additionally or alternatively, the STA 110 or AP 105 may perform aspects of the functions described below using special-purpose hardware.

At block 1005 the STA 110 or the AP 105 may detect at least a first part of an unscheduled Wi-Fi packet transmitted over a Wi-Fi channel. The operations of block 1005 may be performed according to the descriptions of FIGS. 1-6. In some implementations, aspects of the operations of block 1005 may be performed by a channel estimator as described with reference to FIGS. 7-9.

At block 1010 the STA 110 or the AP 105 may perform a channel estimation on the Wi-Fi channel. The operations of block 1010 may be performed according to the descriptions of Figures-6. In some implementations, aspects of the operations of block 1010 may be performed by a channel estimator as described with reference to FIGS. 7-9.

At block 1015 the STA 110 or the AP 105 may estimate an interference on the Wi-Fi channel based on a known non-zero portion of the preamble of the Wi-Fi packet. The operations of block 1015 may be performed according to the descriptions of FIGS. 1-6. In some implementations, aspects of the operations of block 1015 may be performed by an interference estimator as described with reference to FIGS. 7-9.

At block 1020 the STA 110 or the AP 105 may null interference from the Wi-Fi channel during reception of at least a second part of the Wi-Fi packet based at least in part on the channel estimate and the estimated interference. The operations of block 1020 may be performed according to the description of FIGS. 1-6. In some implementations, aspects of the operations of block 1020 may be performed by an interference nulling manager as described with reference to FIGS. 7-9.

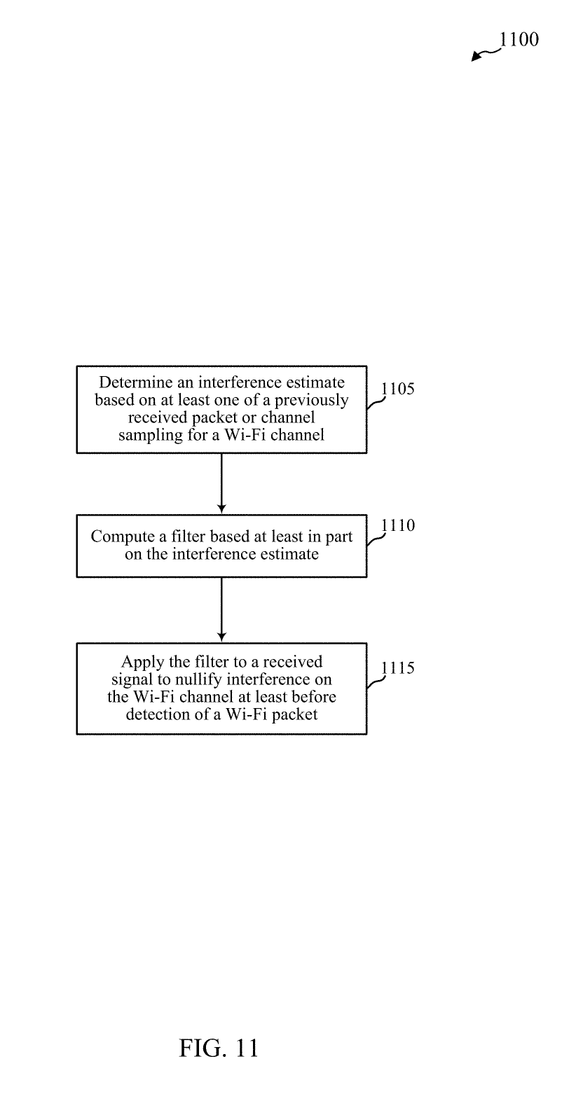

FIG. 11 is a flow chart illustrating an example of a method 1100 for pre-detection interference nulling. The operations of the method 1100 may be implemented by a STA 110 or the AP 105 or its components as described herein. For example, the operations of method 1100 may be performed by an interference nulling manager as described with reference to FIGS. 7-9. In some implementations, a STA 110 or AP 105 may execute a set of codes to control the functional elements of the device to perform the functions described below. Additionally or alternatively, the STA 110 or the AP 105 may perform aspects of the functions described below using special-purpose hardware.

At block 1105, the STA 110 or the AP 105 may determine an interference estimate based on at least one of a previously received packet or channel sampling for a Wi-Fi channel. The operations of block 1105 may be performed according to the description of FIGS. 1-6. In some implementations, aspects of the operations of block 1105 may be performed by an interference estimator as described with reference to FIGS. 7-9.

At block 1110, the STA 110 or AP 105 may compute a filter based at least in part on the interference estimate. The operations of block 1110 may be performed according to the descriptions of FIGS. 1-6. In some implementations, aspects of the operations of block 1110 may be performed by an interference nulling manager as described with reference to FIGS. 7-9.

At block 1115, the STA 110 or the AP 105 may apply the filter to a received signal to null interference on the Wi-Fi channel at least before detection of a Wi-Fi packet. The operations of block 1115 may be performed according to the description of FIGS. 1-6. In some implementations, aspects of the operations of block 1115 may be performed by an interference nulling manager as described with reference to FIGS. 7-9.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described throughout. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus for wireless communication, comprising:
a processor;
memory in electronic communication with the processor; and
instructions stored in the memory and operable, when executed by the processor, to cause the apparatus to:
detect at least a first part of an unscheduled Wi-Fi packet transmitted over a Wi-Fi channel;
perform a channel estimation on the Wi-Fi channel;
estimate an interference on the Wi-Fi channel based on a known non-zero portion of the preamble of the Wi-Fi packet; and
null interference from the Wi-Fi channel during reception of at least a second part of the Wi-Fi packet based at least in part on the channel estimate and the estimated interference.

2. The apparatus of claim 1, wherein:
the estimating the interference is based at least in part on a known or redundant waveform of the known non-zero portion of the preamble of the Wi-Fi packet.

3. The apparatus of claim 1, wherein:
detecting at least the first part of the data packet includes detecting a short training field (STF) of the data packet, wherein the known non-zero portion of the preamble is from one of the STF or a long training field (LTF) of the preamble.

4. The apparatus of claim 3, wherein:
the known non-zero portion of the preamble corresponds to a portion of the STF received after automatic gain control (AGC) settling and decoding or re-encoding of a signal (SIG) field.

5. The apparatus of claim 1, wherein the instructions are further executable by the processor to:
perform a smoothing operation on the Wi-Fi channel or the interference estimate in the frequency domain; and
compute a frequency domain filter based at least in part on the estimated channel or the smoothed interference estimate.

6. The apparatus of claim 5, wherein:
nulling interference from the Wi-Fi channel includes applying the frequency domain filter to a received signal during reception of at least a second part of the Wi-Fi packet.

7. The apparatus of claim 1, wherein the instructions are further executable by the processor to:
calibrate the smoothing operation based at least in part on a modulation and coding scheme (MCS), a signal to interference and noise ratio (SINK), or a number of receive antennas.

8. A method for wireless communication, comprising:
detecting at least a first part of an unscheduled Wi-Fi packet transmitted over a Wi-Fi channel;
performing a channel estimation on the Wi-Fi channel;
estimating an interference on the Wi-Fi channel based on a known non-zero portion of the preamble of the Wi-Fi packet; and
nulling interference from the Wi-Fi channel during reception of at least a second part of the Wi-Fi packet based at least in part on the channel estimate and the estimated interference.

9. The method of claim 8, wherein:
the estimating the interference is based at least in part on a known or redundant waveform of the known non-zero portion of the preamble of the Wi-Fi packet.

10. The method of claim 8, wherein:
detecting at least the first part of the data packet includes detecting a short training field (STF) of the data packet, wherein the known non-zero portion of the preamble is from one of the STF or a long training field (LTF) of the preamble.

11. The method of claim 10, wherein:
the known non-zero portion of the preamble corresponds to a portion of the STF received after automatic gain control (AGC) settling and decoding or re-encoding of a signal (SIG) field.

12. The method of claim 8, further comprising:
performing a smoothing operation on the Wi-Fi channel or the interference estimate in the frequency domain; and
computing a frequency domain filter based at least in part on the estimated channel or the smoothed interference estimate.

13. The method of claim 12, wherein:
nulling interference from the Wi-Fi channel includes applying the frequency domain filter to a received signal during reception of at least a second part of the Wi-Fi packet.

14. The method of claim 8, further comprising:
calibrating the smoothing operation based at least in part on a modulation and coding scheme (MCS), a signal to interference and noise ratio (SINR), or a number of receive antennas.

15. An apparatus for wireless communication, comprising:
a processor;
memory in electronic communication with the processor; and
instructions stored in the memory and operable, when executed by the processor, to cause the apparatus to:
determine an interference estimate based on at least one of a previously received packet or channel sampling for a Wi-Fi channel;
compute a filter based at least in part on the interference estimate; and
apply the filter to a received signal to null interference on the Wi-Fi channel at least before detection of a Wi-Fi packet.

16. The apparatus of claim 15, wherein the instructions are further executable by the processor to:
apply the filter to the received signal occurs based at least in part on at least one of: an absence of a determination that a packet was detected or an absence of a determination that an interference level is below a threshold interference level.

17. The apparatus of claim 15, wherein the instructions are further executable by the processor to:
monitor the Wi-Fi channel to detect a Wi-Fi packet using a legacy packet detector, wherein applying the filter to the received signal further is based at least in part on an absence of detected legacy Wi-Fi packets.

18. The apparatus of claim 15, wherein the instructions are further executable by the processor to:
detect an overlapping basic service set (BSS) physical layer convergence procedure (PLCP) Protocol Data Unit (PPDU);
activate the filter based at least in part on the detection of the overlapping BSS PPDU; and
apply the filter to the received signal occurs after the filter is activated.

19. The apparatus of claim 15, wherein the instructions are further executable by the processor to:
periodically determine the interference estimate via over the air sampling.

20. The apparatus of claim 15, wherein the instructions are further executable by the processor to:
create a null-space filter based at least in part on the interference estimate; and
apply, until a Wi-Fi packet is detected, the null-space filters to null at least some of the interference while keeping at least some noise.

21. The apparatus of claim 15, wherein the instructions are further executable by the processor to:
detect the Wi-Fi packet after applying the filter to the received signal to null the at least some interference.

22. The apparatus of claim 15, wherein the instructions are further executable by the processor to:
detect interference on the Wi-Fi channel based at least in part on at least one of: an energy level received at a receive chain, a ratio of energy of diagonal to energy of off-diagonal elements of the receive chain, or on detection of an interfering packet with a known length.

23. A method for wireless communication, comprising:
determining an interference estimate based on at least one of a previously received packet or channel sampling for a Wi-Fi channel;
computing a filter based at least in part on the interference estimate; and
applying the filter to a received signal to null interference on the Wi-Fi channel at least before detection of a Wi-Fi packet.

24. The method of claim 23, further comprising:
applying the filter to the received signal occurs based at least in part on at least one of: an absence of a determination that a packet was detected or an absence of a determination that an interference level is below a threshold interference level.

25. The method of claim 23, further comprising:
monitoring the Wi-Fi channel to detect a Wi-Fi packet using a legacy packet detector, wherein applying the filter to the received signal further is based at least in part on an absence of detected legacy Wi-Fi packets.

26. The method of claim 23, further comprising:
detecting an overlapping basic service set (BSS) physical layer convergence procedure (PLCP) Protocol Data Unit (PPDU);
activating the filter based at least in part on the detection of the overlapping BSS PPDU; and
applying the filter to the received signal occurs after the filter is activated.

27. The method of claim 23, further comprising:
periodically determining the interference estimate via over the air sampling.

28. The method of claim 23, further comprising:
creating a null-space filter based at least in part on the interference estimate; and
applying, until a Wi-Fi packet is detected, the null-space filters to null at least some of the interference while keeping at least some noise.

29. The method of claim 23, further comprising:
detecting the Wi-Fi packet after applying the filter to the received signal to null the at least some interference.

30. The method of claim 23, further comprising:
detecting interference on the Wi-Fi channel based at least in part on at least one of: an energy level received at a receive chain, a ratio of energy of diagonal to energy of off-diagonal elements of the receive chain, or on detection of an interfering packet with a known length.
